(19) United States
(12) Patent Application Publication
(10) Pub. No.: US 2007/0242355 A1
(43) Pub. Date: Oct. 18, 2007

(54) WAVELENGTH PLATE AND OPTICAL HEAD DEVICE

(75) Inventors: Takashi Takahashi, Tokyo (JP); Nobuki Tanaka, Tokyo (JP); Takaaki Saito, Tokyo (JP); Tatsuya Nakata, Tokyo (JP); Takuya Tsukamoto, Tokyo (JP); Hiroyuki Kitano, Kisarazu-shi (JP); Hiroki Iida, Kisarazu-shi (JP); Fujio Miyagawa, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOPCON

(21) Appl. No.: 11/671,744

(22) Filed: Feb. 6, 2007

(30) Foreign Application Priority Data
Feb. 8, 2006 (JP) 2006-030769

(51) Int. Cl. G02B 5/30

(52) U.S. Cl. 359/500

(57) ABSTRACT

A wavelength plate including an organic thin film adhered to a glass substrate through an adhesive is built in an optical head optical system used in a predetermined using temperature range. The adhesive has a glass transition temperature higher than the predetermined using temperature range, and the linear expansion coefficient (K1) of the adhesive, the linear expansion coefficient (K2) of the organic thin film, and the linear expansion coefficient (K3) of the glass substrate have the relation of K3≦K1 and K1≦K2 under the predetermined using temperature range. The linear expansion coefficient (K1) of the adhesive, the linear expansion coefficient (K2) of the organic thin film and the linear expansion coefficient (K3) of the glass substrate can satisfy the relation of K3<K1<K2 when the temperature within the optical head optical system is an ordinary temperature, and satisfy the relation of K3<K2<K1 when the temperature within the optical head optical system is higher than the glass transition temperature of the adhesive. In the event of fluctuation of laser wavelength by temperature change, the phase difference changes so as to match with this wavelength fluctuation. In an optical head device, the above-mentioned phase difference plate is provided so that its arrangement position is changeable.

### TECHNICAL FIELD

The present invention relates to a wavelength plate and an optical head device and, particularly, relates to a wavelength plate to be used for recording and reproducing information by irradiating an optical storage medium such as a CD (component disc), a DVD (digital versatile disc, Trademark), a Blu-ray Disc (Trademark), or other optical discs with semiconductor laser beam, and an optical head device with the wavelength plate incorporated therein.

### RELATED ART

As the wavelength plates for use in optical head devices, conventionally, an organic thin film of uniaxially stretched polycarbonate or the like has been used, for example, as shown in Japanese Patent Unexamined Publication (JP-A) No. 2000-310718, International Publication (IP) No. WO/2001-16627 A1, Japanese Patent Unexamined Publication (JP-A) No. 2003-139956, Japanese Patent Unexamined Publication (JP-A) No. 2005-62428, US Patent Application Publication (USP) No. 2005-213210 A1, and Japanese Patent Unexamined Publication (JP-A) No. 2005-208588.

On the other hand, long-time operation of the optical head device causes a temperature change with time within the optical head device. When the oscillating wavelength of a semiconductor laser is fluctuated by such a temperature change in an optical head device with a wavelength plate incorporated therein, a predetermined phase difference cannot be obtained when the laser beam passes through the wavelength plate.

Therefore, a wavelength plate capable of ensuring a predetermined phase difference by compensating, in using an optical head device while incorporating a wavelength plate, the wavelength fluctuation of outgoing light from the semiconductor laser by the temperature change and absorbing the deformation with temperature rise of a phase difference film (a typical example of the organic thin film) by an adhesive has been proposed, for example, as shown in JP-A No. 2000-310718, IP No. WO/2001-16627 A1, and JP-A No. 2003-139956.

Further, a wavelength plate having a relation in which the linear expansion coefficient of the adhesive is smaller than the linear expansion coefficient of the phase difference film by reversing the inequality relation of linear expansion coefficients of the adhesive, the phase difference film and the substrate shown in the above-mentioned JP-A No. 2000-310718, IP No. WO/2001-16627 A1 and JP-A No. 2003-139956 and devising the adhesive has been also proposed, for example, as shown in JP-A No. 2005-62428 and USP No. 2005-213210 A1.

Further, a wavelength plate using an adhesive having a glass transition temperature of not lower than 40° C., preferably, not lower than 60° C., and further preferably not lower than 80° C. is described in Japanese Patent Application Laid-Open (JP-A) No. 2005-208588 (refer to Paragraph 0117, p. 21 of the same).

The adhesive used in the above-mentioned conventional wavelength plate had an inflexion point where the heat expansion coefficient is changed by one digit within an optical system operating temperature range in the optical head device because the glass transition temperature is rather lower than an ordinary temperature and within the optical system operating temperature range.

Such a change by one digit of the heat expansion coefficient naturally causes a large change of a stress applied to the phase difference film. This results in serious change of optical characteristics such as phase difference or transmission wave aberration within the operating temperature range.

The adhesives used in the wavelength plates as shown in JP-A No. 2005-62428 and USP No. 2005-213210 A1 become hardened in the using temperature range within the optical head device, because their glass transition temperatures are set to an ordinary temperature of about 25° C., different from the adhesives in the wavelength plates shown in JP-A No. 2000-310718, IP No. WO/2001-16627 A1 and JP-A No. 2003-139956, and cannot work at all or exhibit sufficient phase difference characteristic in the event of a thermal change exceeding the using temperature range.

Although it is described in JP-A No. 2005-208588 that the magnitude of change in in-plane aberration of the wavelength plate can be minimized by combining an adhesive (A) with an adhesive (B), and a wavelength plate with excellent long-term reliability which is hardly affected by the using environment or manufacturing environment can be thus obtained (refer to Paragraph 0122, p. 22 of the same), the single use of the adhesive (B) for lamination of the phase difference film to glass causes peeling or the like because the adhesive is hard.

### SUMMARY OF THE INVENTION

An object of the present invention is to provide a wavelength plate with minimized influence on an organic thin film (phase difference film) and stabilized optical characteristics, in which an adhesive remains soft without hardening even in a high-temperature environment within an optical head device, and the thermal expansion coefficient of the adhesive can be substantially equalized to that of the organic thin film (phase difference film) so that the phase difference film and the adhesive act as if they are thermally the same substance even if thermal change occurs in the optical head optical system by setting the glass transition temperature of the adhesive in the using temperature range of the optical head device not lower than an ordinary temperature, and an optical head device with the wavelength plate incorporated therein.

A first aspect of the invention is a wavelength plate to be built in an optical head optical system used in a predetermined using temperature range, including an organic thin film adhered to a glass substrate through an adhesive, which is improved so that the adhesive has a glass transition temperature higher than the predetermined using temperature range, and the linear expansion coefficient of the adhesive (K1), the linear expansion coefficient of the organic thin film (K2) and the linear expansion coefficient of the glass substrate (K3) satisfy the relation of K3≦K1 and K1≦K2 in the predetermined using temperature range.

A second aspect of the invention is a wavelength plate to be built in an optical head optical system, including an organic thin film adhered to a glass substrate through an adhesive, which is improved so that the linear expansion coefficient (K1) of the adhesive, the linear expansion coefficient (K2) of the organic thin film, and the linear expansion coefficient (K3) of the glass substrate satisfy the relation of K3<K1<K2 when the temperature within the optical head optical system is an ordinary temperature, and satisfy the relation of K3<K2<K1 when the temperature within the optical head optical system is higher than the glass transition temperature of the adhesive.

A third aspect of the invention is that the ordinary temperature is about 25° C.

A fourth aspect of the invention is an optical head device provided with the wavelength plate described above.

According to the present invention, the glass transition temperature of the adhesive is set in the using temperature range of the optical head device not lower than the ordinary temperature, whereby the adhesive remains soft without hardening even in a high-temperature environment within the optical head device, and the thermal expansion coefficient of the adhesive can be substantially equalized to that of the organic thin film (phase difference film), so that the phase difference film and the adhesive act as if they are thermally the same substance even if thermal change occurs within the optical head optical system, a wavelength plate with minimized influence on an organic thin film (phase difference film) and stabilized optical characteristic and an optical head device with the wavelength plate incorporated therein can thus be provided.

### BRIEF DESCRIPTION OF THE DRAWINGS

FIG. 1 is a sectional view of a retardation film according to one embodiment of the present invention;

FIG. 2 is a sectional view of a retardation film according to another embodiment of the present invention;

FIG. 3 is an illustrative view showing one example of an optical head device according to the present invention;

FIG. 4 is a view showing one of a series of processes for manufacturing the retardation film shown in FIG. 1;

FIG. 5 is a view showing the process following the process shown in FIG. 4;

FIG. 6 is a view showing the process following the process shown in FIG. 5;

FIG. 7 is a view showing the process following the process shown in FIG. 6;

FIG. 8 is a graph showing the relation between phase difference (Re value) and temperature change for three kinds of retardation films, particularly, the change of Re value at 650 nm;

FIG. 9 is a graph showing the relation between the phase difference value (Re value) and temperature change for three kinds of retardation films, particularly, the change of Re value at 780 nm;

FIG. 10 is a graph showing the relation between phase difference (Re value) and temperature change for three kinds of retardation films, particularly, the magnitude of change at 650 nm; and

FIG. 11 is a graph showing the relation between phase difference (Re value) and temperature change for three kinds of retardation films, particularly, the magnitude of change at 780 nm.

### EMBODIMENTS

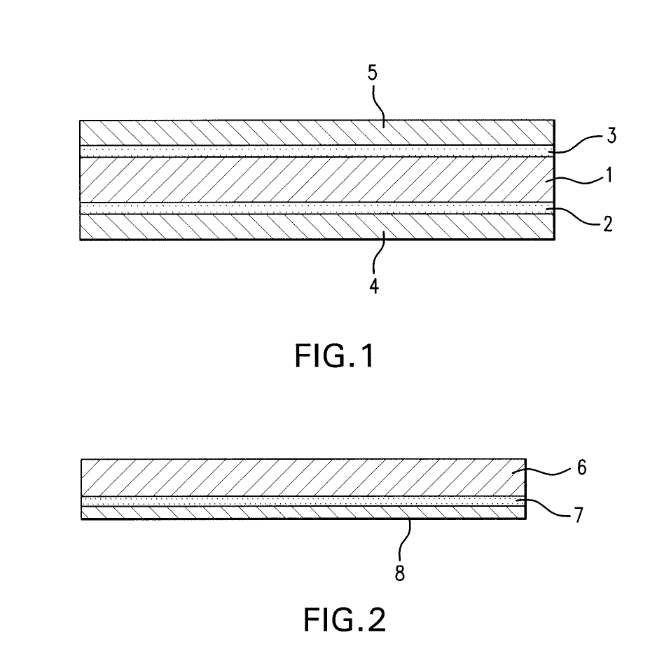

FIG. 1 shows a wavelength plate in which adhesives 2, 3 are applied to both sides of an organic thin film (phase difference film), and two fixed substrates 4, 5 are adhered so as to nip the organic thin film 1 from both sides thereof through the adhesives 2, 3.

In the embodiment of FIG. 1, preferably, the organic thin film 1 is 0.2 to 1.0 mm thick, the adhesives 2, 3 are 5 to 20 μm thick, and the fixed substrates 4, 5 are 0.2 to 2.0 mm thick.

FIG. 2 shows a wavelength plate in which an adhesive 7 is applied to one side of an organic thin film 6, and one fixed substrate 8 is adhered from above the one side having the adhesive 7.

In the embodiment of FIG. 2, preferably, the organic thin film 6 is 0.2-1.0 mm thick, the adhesive 7 is 5 to 20 μm thick, and the fixed substrate 8 is 0.2 to 2.0 mm thick.

The fixed substrates 4, 5, 8 in FIGS. 1 and 2 are preferably glass plates, but may be composed of other materials such as a plastic plate or an organic thin film of cycloolefin-based polymer or polycarbonate.

When a fixed substrate formed of the organic thin film is used, although not shown in the drawings, the fixed substrate can be fixed to the phase difference film by pressure welding or fusion without using any adhesive. The fixed substrate and the phase difference film after pressure welding or fusing have a structure in which the adhesive is omitted from the structures of FIGS. 1 and 2. In this case, preferably, the organic thin film constituting the fixed substrate is 0.2-1.0 mm thick, and the organic thin film constituting the phase difference film is 5 to 20 μm thick.

When a phase difference film is used as the organic thin films 1, 6 in the embodiments of FIGS. 1 and 2, for example, a cycloolefin-based polymer or polycarbonate such as ARTON (Trademark) manufactured by JSR, APEL (Trademark) manufactured by Mitsui Chemicals, or ZEONEX (Trademark) manufactured by Zeon can be used.

When the fixed substrates 4, 5, 8 are glass substrates, the linear expansion coefficient of the organic thin films 1, 6 is K2, the linear expansion coefficient K1 of the adhesives 2, 3, 7 is K1, and the linear expansion coefficient of the glass substrates 4, 5, 8 is K3, the adhesives 2, 3, 7 have a glass transition temperature higher than a predetermined using temperature range, and the linear expansion coefficient K1 of the adhesives 2, 3, 7, the linear expansion coefficient K2 of the organic thin films 1, 6 and the linear expansion coefficient K3 of the glass substrates 4, 5, 8 satisfy the relation of K3≦K1 and K1≦K2 under the predetermined using temperature range.

The linear expansion coefficient K1 of the adhesives 2, 3, 7, the linear expansion coefficient K2 of the organic thin films 1, 6, and the linear expansion coefficient of the glass substrates 4, 5, 8 satisfy the relation of K3<K1<K2 when the temperature within the optical head optical system is an ordinary temperature, and satisfy the relation of K3<K2<K1 when the temperature within the optical head optical system is higher than the glass transition temperature of the adhesives 2, 3, 7.

The glass transition temperature of the adhesive is about 40° C.

The adhesives 2, 3, 7 having such a special relation are produced, and the fixed substrates 4, 5, 8 are adhered to the organic thin films 1, 6 through the special adhesives 2, 3, 7. For enhancing the adhesiveness of the adhesives 2, 3, 7, a primer can be used in combination.

One concrete example will be described.

In using a phase difference film as the organic thin films 1, 6, the linear expansion coefficient K2 is 7.0-9.0×10⁻⁵/° C. when its glass transition temperature is lower than 110° C. (t<Tg 110° C.). This is a representative value of general polycarbonate. The glass transition temperature of the adhesives 2, 3, 7 is generally about 40° C., and the linear expansion coefficient K1 thereof is 2.6×10⁻⁵/° C. at a temperature higher than 40° C., and 4.0×10⁻⁴/° C. at a temperature lower than 40° C. (generally at 20 to 25° C.).

In this concrete example, the linear expansion coefficient K3 of the fixed substrates 4, 5, 8 that are glass substrates is 95×10⁻⁷/° C. In the using temperature range of the optical system of the optical head device, the linear expansion coefficient K1 of the adhesives 2, 3, 7, the linear expansion coefficient K2 of the organic thin films 1, 6, and the linear expansion coefficient K3 of the glass substrates 4, 5, 8 satisfy the relation of K3≦K1 and K1≦K2.

The linear expansion coefficient K1 of the adhesives 2, 3, 7, the linear expansion coefficient K2 of the organic thin films 1,6, and the linear expansion coefficient K3 of the glass substrates 4, 5, 8 satisfy the relation of K3<K1<K2 when the temperature within the optical system of the optical head device is an ordinary temperature (generally about 25° C.), and satisfy the relation of K3<K2<K1 when the temperature within the optical head optical system is higher than the glass transition temperature of the adhesive 2, 3, 7.

Accordingly, the organic thin film, the adhesive, and the glass substrate remain soft without hardening even in a high-temperature environment, and the adhesiveness is thus stabilized.

When the fixed substrates 4, 5, 8 are made of plastics such as polycarbonate, the relation of K3≦K2 and K3<K1 is satisfied since the linear expansion coefficient K3 is 7.0×10⁻⁵/° C.

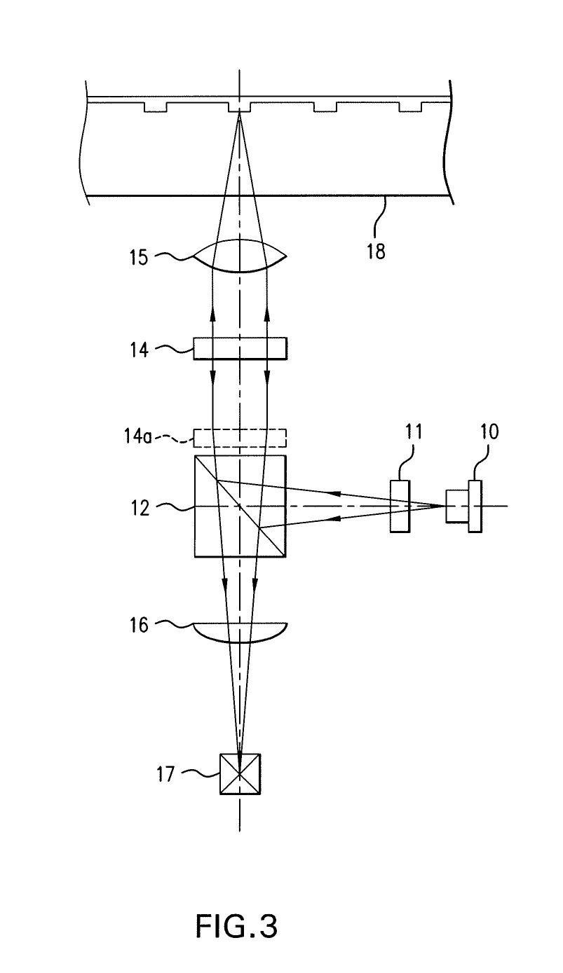

FIG. 3 shows one example of an optical head device according to the present invention.

The optical head device comprises a laser diode 10 (light source) that is a semiconductor laser, a diffraction grating 11, a polarizing beam splitter 12, a collimator lens (not shown), a wavelength plate 14, an objective lens 15, a cylindrical lens 16, a light detector 17, and others.

The arrangement position of the wavelength plate 14 is changeable along the optical axis between a position shown by the full line and a position 14a shown by the broken line within the device.

A laser beam emitted from the laser diode 10 is diffracted by the diffraction grating 11, reflected by the polarizing beam splitter 12, and directed to a CD 18 (or DVD, Blu-ray Disc).

The light reflected by the polarizing beam splitter 12 is regulated in phase to a predetermined wavelength (λ/4 or λ/2) by the wavelength plate 14, and radiated to the CD 18 (or DVD, Blu-ray Disc) through the objective lens 15. The light reflected thereby is detected by the light detector 17.

Information in the CD 18 (or DVD, Blu-ray Disc) as an information storage medium is reproduced or stored in such a manner.

The light emitted from the laser diode 10 may be blue laser. In this case, the CD 18 performs recording and reproduction to an HD-DVD (Trademark) or Blu-ray Disc. Two or more laser diodes 10, light detectors 17, diffracting gratings 11, polarizing beam splitters 12 and other elements can be set.

The optical head device shown in FIG. 3 comprises a retardation film according to the present invention. The wavelengths used in this optical head device are preferably λ₁=405±20 nm, λ₂=655±20 nm, and λ₃=785±20 nm.

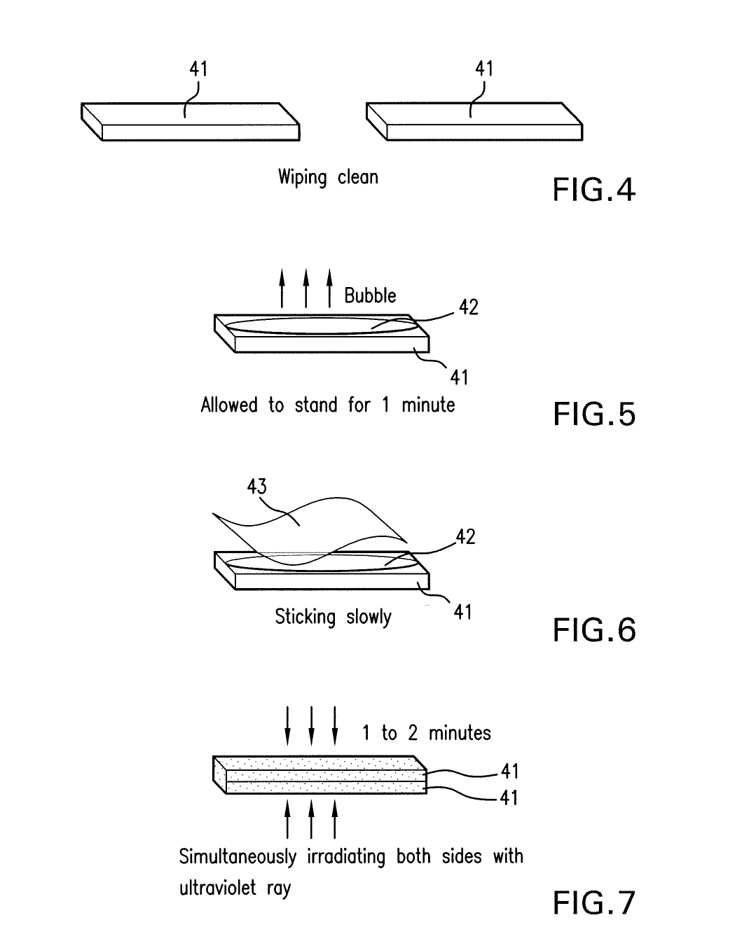

One example of the manufacturing method of the wavelength plate shown in FIG. 1 will be described in reference to FIGS. 4 to 7.

As the phase difference film composed of the organic thin film, a commercially available one cut in a predetermined size can be used.

As the adhesive, an ultraviolet hardenable adhesive is preferably used.

As the fixed substrate, one having an AR coat satisfying a specification on one side is preferably used.

The size of the glass plate used as the fixed substrate preferably has a size of 76 mm×32 mm×0.97 (thickness) mm.

A phase difference film 43 (FIG. 6) used as the organic thin film 1 of FIG. 1 preferably has a size matched to the dimension of the glass-made fixed substrate.

The adhesion work of the phase difference film 43 to the glass-made fixed substrate 41 is performed in the following procedures (a) to (d).

(a) The adhering surface (the opposite side to AR) of the glass-made fixed substrate 41 with AR film is sufficiently wiped as shown in FIG. 4.

In the embodiment of FIG. 2 one glass-made fixed substrate 41 with AR film is used while two substrates are used in the embodiment of FIG. 1.

(b) As shown in FIG. 5, about 1.0 g of an adhesive 42 is uniformly applied to the surface with no AR of the glass-made fixed substrate 41. The adhesive 42 is spread so as not to generate bubbles as much as possible. After spreading, the substrate is allowed to stand for about 1 minute to release the bubbles.

(c) A protective sheet (not shown) on one side of the phase difference film 43 is peeled, as shown in FIG. 6, and the phase difference film 43 is carefully and slowly stuck to the glass-made fixed substrate 41 from an end side so as not to include bubbles while positioning the ends of the both (phase difference alignment).

(d) After the adhesion of the phase difference film 43 to the one side of the glass-made fixed substrate 41, the adhering surface on one side of the other glass-made fixed substrate 41 is adhered to the other side of the phase difference film 43 in the same manner as the above-mentioned (a) to (c).

After the two glass-made fixed substrates 41 are adhered to the phase difference film 43 so as to interpose the phase difference film between them, both sides of the glass-made fixed substrates 41 are pressurized at a pressure of about 5 to 10 kg/cm² to uniform the layer thickness of the adhesive 41.

That is the end of the adhesion work.

Thereafter, the applied adhesive 41 is hardened by irradiation with ultraviolet ray in the following procedures (e) and (f). The illuminance of the ultraviolet ray is set to 10-50 mW/cm² (at 365 nm). As an irradiation device, a high-pressure mercury lamp manufactured by Ushio can be used.

(e) Both the sides of the glass-made fixed substrates 41 are simultaneously irradiated with ultraviolet ray for 1 to 2 minutes, as shown in FIG. 7, in the state where the phase difference film 43 is interposed between the two glass-made fixed substrates 41.

(f) The outer surfaces of the two glass-made fixed substrates 41 are wiped clean with acetone.

That is the end of the work for adhering the two glass-made fixed substrates 41 to both the sides of the phase difference film 43 in a sandwich form.

Thereafter, the resulting plate is cut in a predetermined size as occasion demands and cleaned, whereby a desired wavelength plate can be obtained.

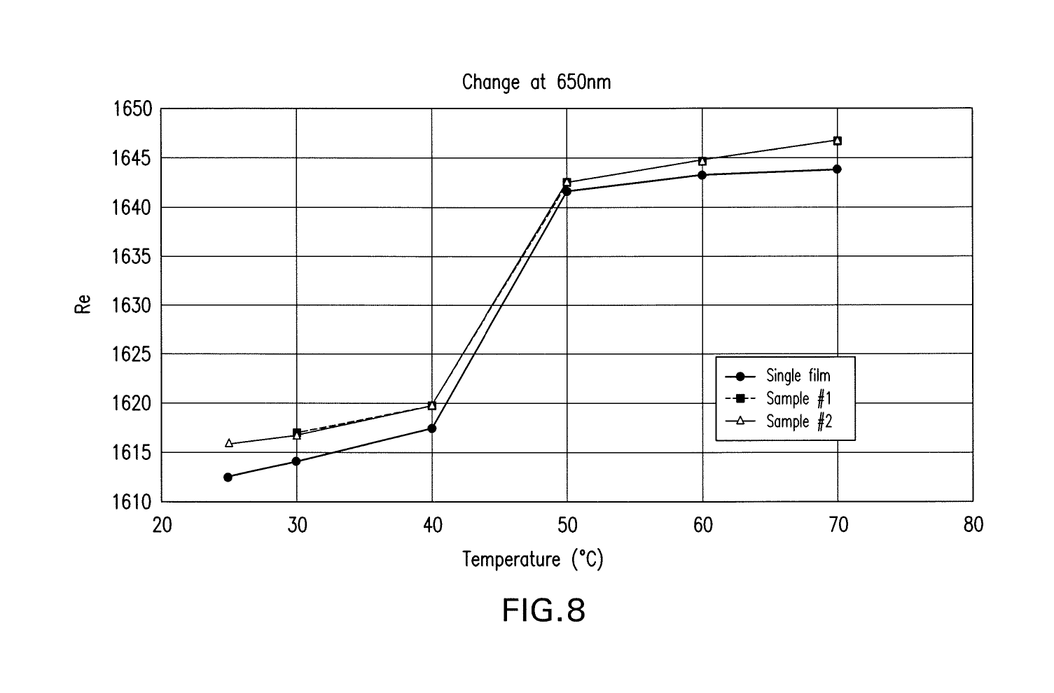

The relation between phase difference (Re value or retardation value) and temperature change will be then described in reference to FIGS. 8 to 11.

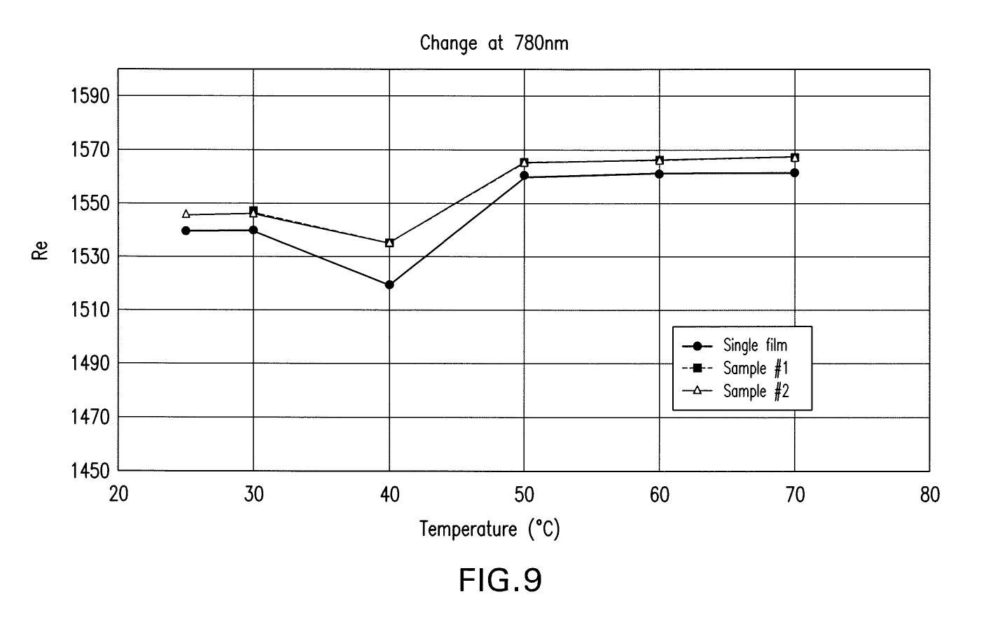

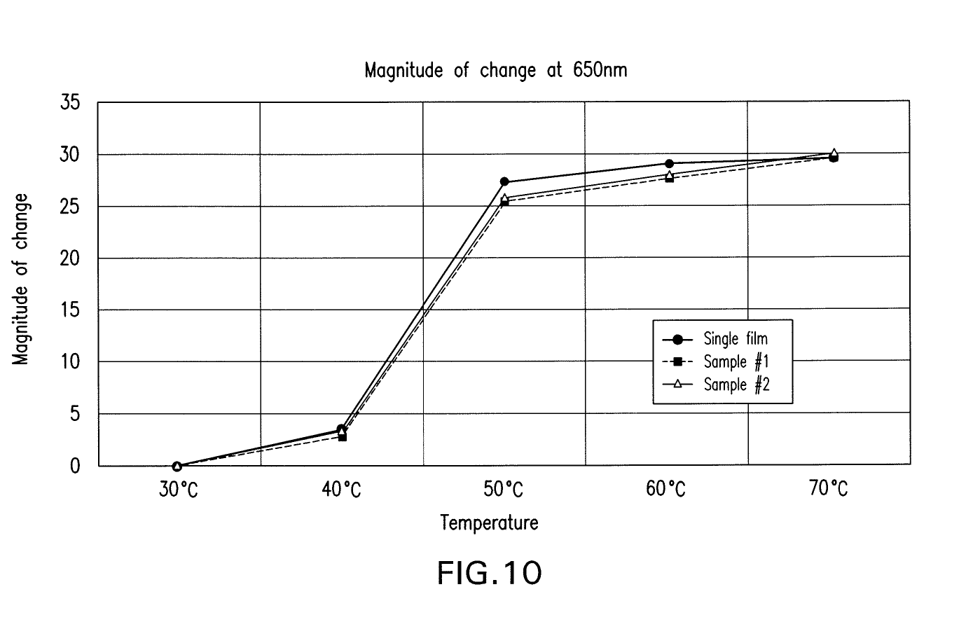

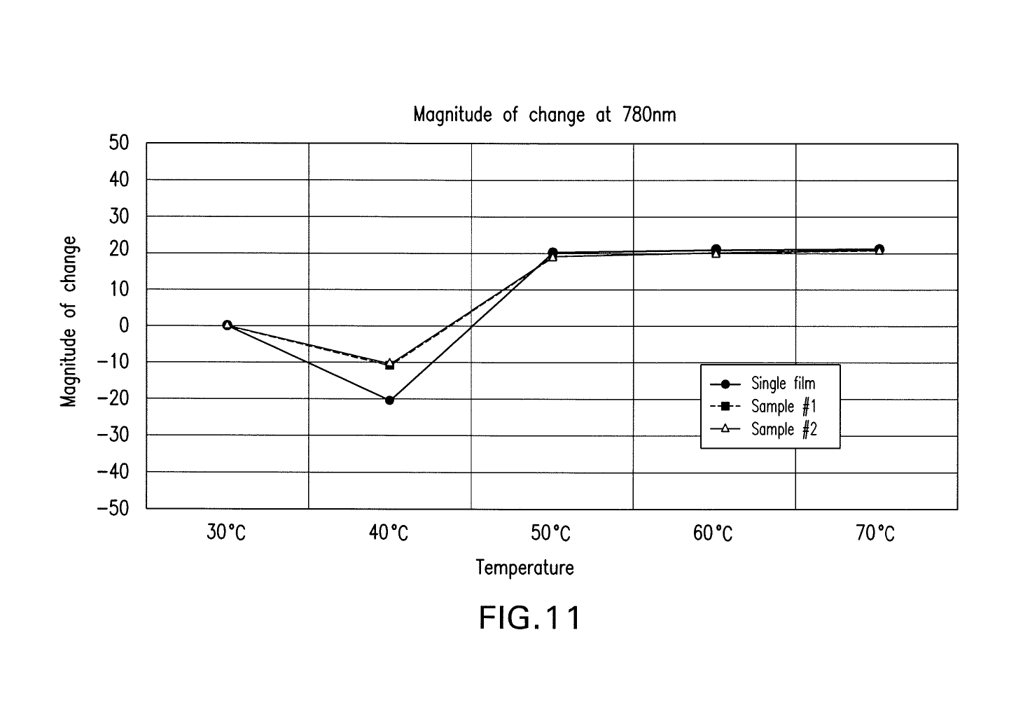

FIGS. 8 and 9 show the change of Re value at 650 nm and at 780 nm, respectively, and FIGS. 10 and 11 show the magnitude of change at 650 nm and at 780 nm, respectively.

In each of FIGS. 8 to 11, the relation between phase difference (Re value or retardation value) and temperature change is shown with respect to three kinds of wavelength plates, or a single film, Sample #1 and Sample #2. The change of Re value at 405 nm is omitted since it has the same relation between phase difference (Re value or retardation value) and temperature change as those at wavelengths of 650 nm and at 780 nm with respect to the three kinds of wavelength plates, or the single film, Sample #1 and Sample #2.

Namely, FIGS. 8 to 11 show a graph in use of a single phase difference film composed of an organic thin film, a graph in use of a wavelength plate (Sample #1) including two glass-made fixing substrates adhered so as to interpose the film between them through an adhesive, and a graph in use of a wavelength plate (Sample #2) comprising one glass-made fixing substrate adhered to the film through an adhesive.

Sample #1 has the structure shown in FIG. 1, and Sample #2 has the structure shown in FIG. 2, while the structure of the single phase difference film is not shown.

As is apparent from the graphs of FIGS. 8 to 11, the change of retardation value (Re value) in the single phase difference film is the same as that in the wavelength plates including lamination using the adhesive as shown in FIGS. 1 and 2. Particularly, even at a high temperature of not lower than 80° C., the change of retardation value is the same. Accordingly, even if the environmental temperature within the optical head device is raised to a high temperature of not lower than 150° C., the phase difference plate is never affected by the temperature change by laser beam.

Thus, even if the phase difference plate is moved between the position 14 shown by the full line and the position 14a shown by the broken line in FIG. 3, or the phase difference plate 14 is moved and arranged in an optional position between a position close to a laser light source (laser diode 10) within the optical head device and a position distant therefrom, the phase difference plate 14 is never affected by the temperature change by laser beam. Therefore, the freedom of design for arrangement of the phase difference plate within the optical head device is increased. Consequently, the conformability to various kinds of optical head devices can be increased.

1. A wavelength plate to be built in an optical head optical system and used in a predetermined using temperature range, comprising an organic thin film adhered to a glass substrate through an adhesive,
the adhesive having a glass transition temperature higher than the predetermined using temperature range, and
wherein the linear expansion coefficient (K1) of the adhesive, the linear expansion coefficient (K2) of the organic thin film, and the linear expansion coefficient (K3) of the glass substrate satisfy the relation of K3≦K1 and K1≦K2.

2. A wavelength plate to be built in an optical head optical system, comprising an organic thin film adhered to a glass substrate through an adhesive,
wherein the linear expansion coefficient (K1) of the adhesive, the linear expansion coefficient (K2) of the organic thin film and the linear expansion coefficient (K3) of the glass substrate satisfy the relation of K3<K1<K2 when the temperature within the optical head optical system is an ordinary temperature, and satisfy the relation of K3<K2<L1 when the temperature within the optical head optical system is higher than the glass transition temperature of the adhesive.

3. The wavelength plate according to claim 2, wherein the ordinary temperature is about 25° C.

4. An optical head device comprising the wavelength plate according to claim 1.

5. An optical head device comprising the wavelength plate according to claim 2.
